(19) United States
(12) Patent Application Publication
(10) Pub. No.: US 2006/0232530 A1
(43) Pub. Date: Oct. 19, 2006

(54) Information processing apparatus

(75) Inventor: Norikazu Nagasawa, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/405,502

(22) Filed: Apr. 18, 2006

(30) Foreign Application Priority Data
Apr. 18, 2005 (JP) 2005-120398

(51) Int. Cl. G09G 3/36

(52) U.S. Cl. 345/87; 345/90

(57) ABSTRACT

According to one embodiment, an information processing apparatus includes, the light source including a first area including first and second light emitting elements, and a second area including third and fourth light emitting elements, the third light emitting element being connected in series to the first light emitting element, the fourth light emitting element being connected in series to the second light emitting element, a first control circuit connected to an anode side of the first light emitting element and a cathode side of the third light emitting element, and configured to adjust a value of current flowing in the first and third light emitting elements, and a second control circuit connected to an anode side of the second light emitting element and a cathode side of the fourth light emitting element, and configured to adjust a value of current flowing in the second and fourth light emitting elements.

### CROSS-REFERENCE TO RELATED APPLICATIONS

This application is based upon and claims the benefit of priority from Japanese Patent Application No. 2005-120398, filed Apr. 18, 2005, the entire contents of which are incorporated herein by reference.

### BACKGROUND

1. Field

One embodiment of the invention relates to an information processing apparatus, for example, having a display unit which includes light emitting elements as a light source.

2. Description of the Related Art

In recent portable terminal devices, a display unit such as a liquid crystal display (LCD) includes light emitting elements such as light emitting diodes (LEDs) as a light source.

Jpn. Pat. Appln. KOKAI Publication No. 2001-76525 discloses an illuminating device in which LEDs connected to a first power supply control circuit and LEDs connected to a second power supply control circuit are alternately arranged to reduce the nonuniformity of the brightness of a display unit, i.e., improve the uniformity of the brightness of the display unit.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an external appearance of an information processing apparatus according to an embodiment of the present invention;

FIG. 2 is an exemplary block diagram showing an example of the system configuration of the information processing apparatus shown in FIG. 1;

FIG. 3 is an exemplary block diagram showing an example of the configuration of an LED driving circuit and white LEDs;

FIG. 4 is an exemplary view showing the configuration of a power supply control circuit and the white LEDs;

FIG. 5 is an exemplary view showing an example of the state of a display surface of an LCD in the case where white LEDs connected to any of power supply control circuits do not emit light;

FIG. 6 is an exemplary view showing a printed-circuit board on which white LEDs are mounted, and a light guiding plate;

FIG. 7 is an exemplary view showing the printed-circuit board on which the white LEDs are mounted, and an interface board connected to the printed-circuit board; and

FIG. 8 is an exemplary block diagram showing a modification of the system configuration of the information processing apparatus.

### DETAILED DESCRIPTION

Various embodiments according to the invention will be described hereinafter with reference to the accompanying drawings. In general, according to one embodiment of the invention, an information processing apparatus comprises, a display panel which displays an image, a light source which illuminates the display panel, the light source including a first light emitting area in which first and second light emitting elements are arranged, and a second light emitting area which is adjacent to the first light emitting area, and in which third and fourth light emitting elements are arranged, the third light emitting element being connected in series to the first light emitting element, the fourth light emitting element being connected in series to the second light emitting element a first control circuit connected to an anode side of the first light emitting element and a cathode side of the third light emitting element, and configured to adjust a value of current flowing in the first and third light emitting elements and a second control circuit connected to an anode side of the second light emitting element and a cathode side of the fourth light emitting element, and configured to adjust a value of current flowing in the second and fourth light emitting elements.

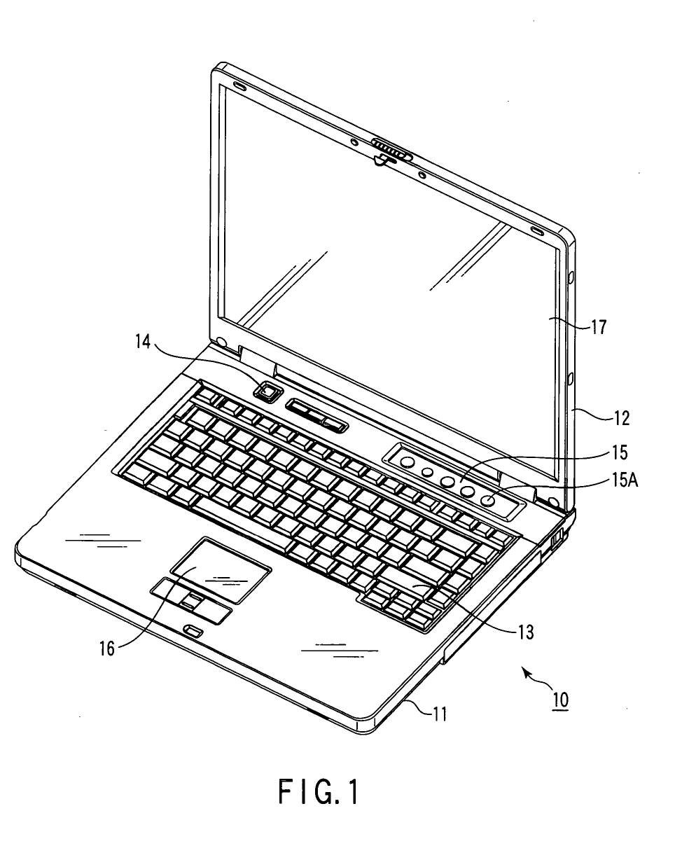

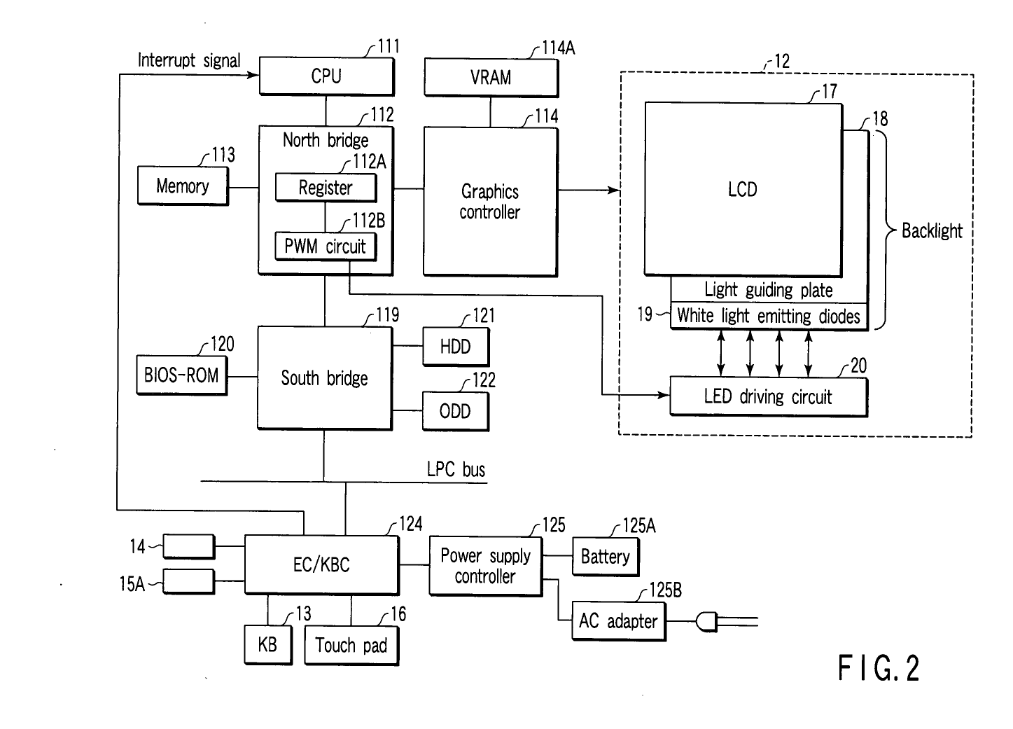

First of all, the structure of an information processing apparatus according to the embodiment of the present invention will be explained with reference to FIGS. 1 and 2. The information processing apparatus has been provided as a portable notebook computer 10 which can be driven by a battery.

FIG. 1 is a perspective view showing that a display unit 12 of the notebook computer 10 is opened. The computer 10 comprises a computer main body 11 and the display unit 12. The display unit 12 incorporates a display panel which comprises a liquid crystal display (LCD) 17 and a backlight. A display screen of the LCD 17 is located substantially at the center of the display unit 12. The LCD 17 comprises a transmission type of liquid crystal panel. In the display unit 12, the backlight is located on a rear surface of the LCD 17. The backlight functions as an illuminating unit of the display unit 12. The backlight includes a group of light emitting elements such as white light emitting diodes (LEDs) as a light source. Thus, the life of the backlight increases, and the power consumption of the backlight lowers.

The display unit 12 is supported by the computer main body 11, and is rotatable between an open position in which it is opened to expose an upper surface of the computer main body 11 and a closed position in which it is closed to cover the upper surface of the computer main body 11. The computer main body 11 includes a thin box-shaped housing. On an upper surface thereof, a keyboard (KB) 13, a power button 14, an input operation panel 15 and a touch pad 16 are provided. The power button is a button for turning on/off a power supply.

The input operation panel 15 is an input device for causing an event to be issued, and is provided with a plurality of buttons for starting a plurality of functions corresponding to a plurality of events, respectively. As one of the plurality of buttons, a brightness control button 15A is provided.

The brightness control button 15A is a button switch for adjusting the brightness of the LCD 17, i.e., the brightness of the white LEDs. When the brightness control button 15A is pressed by a user, an event for instructing the white LEDs to increase or decrease the brightness thereof (to a high brightness or low brightness) is generated. The computer 10 has a brightness control function of switching the brightness of the white LEDs in eight levels, i.e., brightness levels 1 to 8. In the above embodiment, the brightness of the white LEDs is changed by one level from level 8 to level 1 and then back to level 8, each time the brightness control button 15A is pressed by the user.

The system configuration of the computer 10 will be explained with reference to FIG. 2.

The computer 10, as shown in FIG. 2, comprises a CPU 111, a North bridge 112, a main memory 113, a graphics controller 114, a South bridge 119, a BIOS-ROM 120, a hard disk drive (HDD) 121, an optical disk drive (OCD) 122, an embedded controller/keyboard controller IC (EC/KBC) 124 and a power supply controller 125, etc.

The CPU 111 is a processor provided for controlling the operation of the computer 10, and executes an operating system (OS) and kinds of application programs which are loaded from the HDD 121 from the main memory 113.

Furthermore, the CPU 111 also executes a Basic Input Output System (BIOS) stored in the BIOS-ROM 120. The BIOS is a program for controlling hardware, and has a function of controlling the brightness of the white LEDs. In order to control the brightness thereof, the BIOS uses a brightness control table in which brightness control data items respectively corresponding to brightness levels 8 to 1 are set.

The North bridge 112 is a bridge device which connects a local bus and the South bridge 119. In the North bridge 112, a brightness control register 112A and a pulse width modulation (PWM) circuit 112B, etc. are provided as hardware logics for controlling the brightness. The brightness control register 112A is an I/O register to and from which data is written and read by the CPU 111. The BIOS writes brightness control data associated with a target brightness level to the brightness control register 112A. The PWM circuit 112B generates a PWM signal associated with the brightness control data written to the brightness control register 112A. The duty ratio of the PWM signal changes in accordance with the value indicated in the brightness control data. The PWM signal generated from the PWM circuit 112B is sent as a brightness control signal to an LED driving circuit 20 provided in the display unit 12.

The LED driving circuit 20 is a circuit for driving the white LEDs 19. The white LEDs 19 are attached to one end of a light guiding plate 18 provided on the rear surface of the LCD 17. Light from the white LEDs 19 is radiated from a surface of the LCD 17 by the light guiding plate 18. The light guiding plate 18 and the white LEDs 19 form the backlight. The LED driving circuit 20 includes a plurality of power supply control circuits each of which functions as a boost DC-DC converter. Each of the power supply control circuits adjusts the value of a driving voltage to be supplied to the white LEDs 19 in accordance with the PWM signal output from the PWM circuit 112B, in order to adjust the value of current flowing in the white LEDs 19.

Furthermore, the North bridge 112 also incorporates a memory controller for controlling access to the main memory 113, and has a function of performing communication with the graphics controller 114 through an accelerated graphics port (AGP) bus.

The LCD 17 is used as a display monitor of the computer 210, and the graphics controller 114 is a display controller for controlling the LCD 17. The graphics controller 114 includes a video memory (VRAM) 114A, and produces a video signal which is used to form an image to be displayed on the LCD 17 of the display unit 12, from display data which is written to the video memory 114A with an OS/application program.

The South bridge 119 controls each of devices located on a low pin count (LPC) bus. The South bridge 119 incorporates an integrated drive electronics (IDE) controller for controlling the HDD 121 and the ODD 122. Further, the South bridge 119 also has a function of controlling access to the BIOS-ROM 120.

The HDD 121 is a storage device for storing kinds of software and data. The HDD 121 stores the above operating system and kinds of application systems, etc.

The ODD 122 is a drive unit for driving a storage medium such as a DVD, a CD or the like, where video data is stored as video contents.

The EC/KBC 124 is a one-chip microcomputer in which an embedded controller for controlling power and a keyboard controller for controlling the keyboard (KB) 13 and the touch pad 16 are formed integral with each other. The EC/KBC 124 generates an interrupt signal such as a system management interrupt (SMI) to indicate that an event for changing the brightness is issued, when the brightness control button 15A is pressed by the user. Further, the EC/KBC 124 is operated in cooperation with the power supply controller 125 to turn on/off the computer 10 in accordance with the operation of the power button 14 by the user.

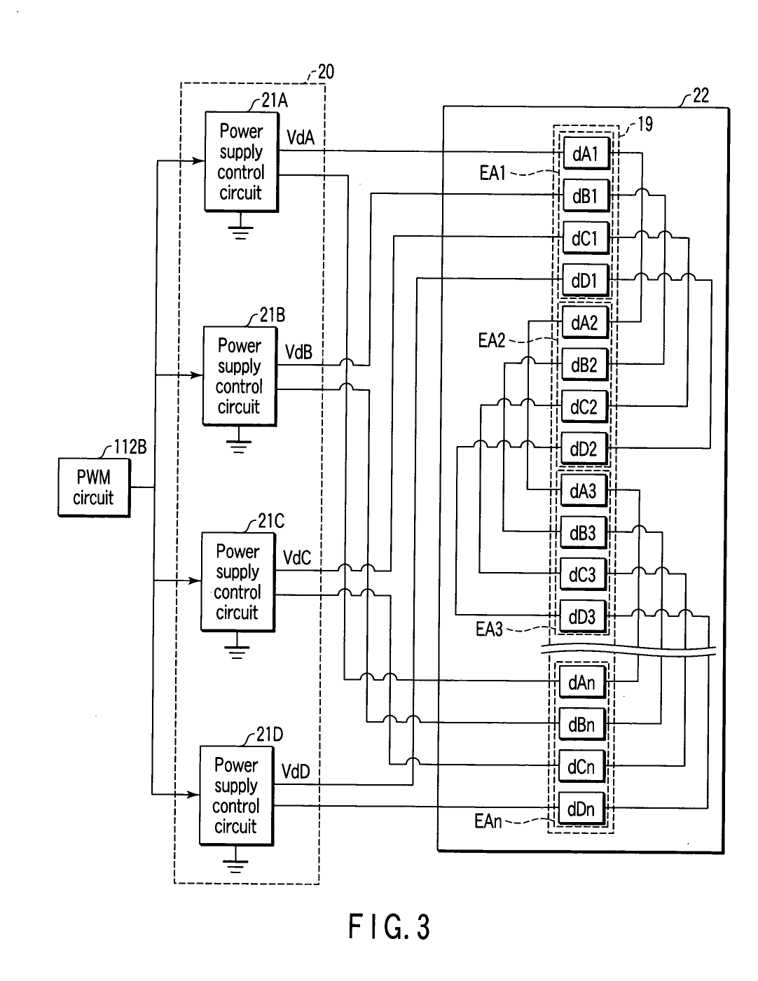

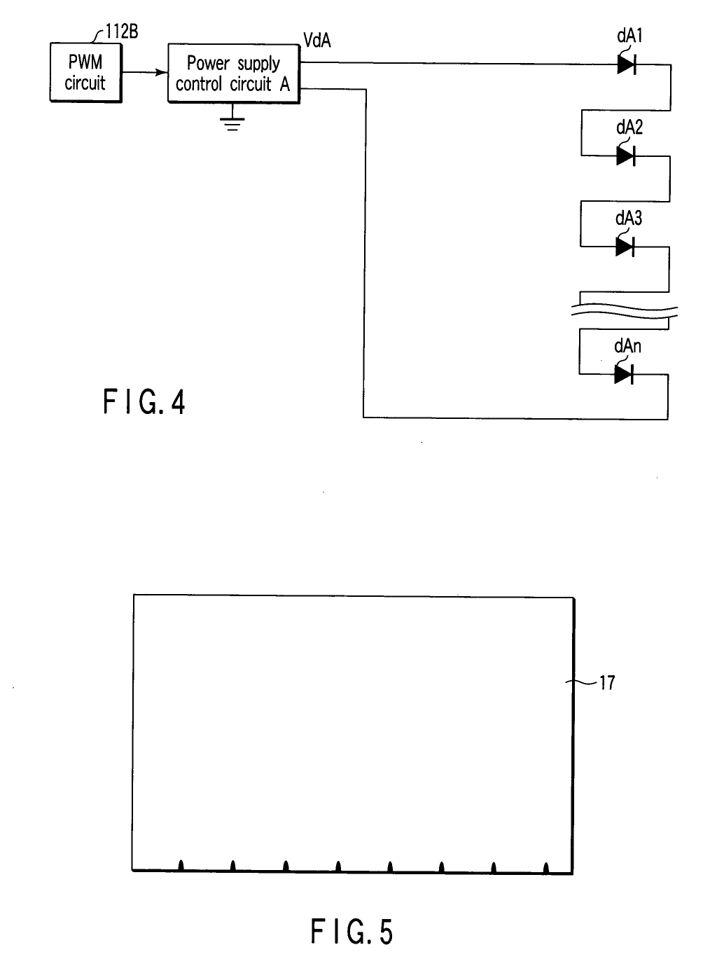

The structures of the white LEDs 19 and the LED driving circuit 20 will be explained with reference to FIGS. 3 and 4. The white LEDs 19 are mounted on a printed-circuit board 22 having a plurality of wiring layers, and are arranged in one direction. In the printed-circuit board 22, areas in which the white LEDs are mounted are provided as a first light emitting area EA1, a second light emitting area EA2, a third light emitting area EA3, . . . an n-th light emitting area EAn. It should be noted that a flexible printed-circuit board may be used in place of the printed-circuit board 22.

In the first light emitting area EA1, a white LED dA1 (first light emitting element), a white LED dB1 (second light emitting element), a white LED dC1, . . . a white LED dD1 are arranged in this order. In the second light emitting area EA2, a white LED dA2 (third light emitting element), a white LED dB2 (fourth light emitting element), a white LED dC2, . . . a white LED dD2 are arranged in this order. In the third light emitting area EA3, a white LED dA3, a white LED dB3, a white LED dC3, . . . a white LED dD3 are arranged in this order. In the n-th light emitting area EAn, a white LED dAn, a white LED dBn, a white LED dCn, . . . a white LED dDn are arranged in this order.

The white LEDs dA1, dA2, dA3, . . . dAn are connected in series to each other. The white LEDs dB1, dB2, dB3, . . . dBn are connected in series to each other. The white LEDs dC1, dC2, dC3, . . . dCn are connected in series to each other. The white LEDs dD1, dD2, dD3, . . . dDn are connected in series to each other.

The anode of one of the outermost ones of the white LEDs dA1, dA2, dA3, . . . dAn connected in series and the cathode of the other, i.e., the anode of the white LED dA1 and the cathode of the white LED dAn, are connected to an associated one of the power supply circuits in the LED driving circuit 20, i.e., a power supply control circuit 21A. The anode of one of the outermost ones of the white LEDs dB1, dB2, dB3, . . . dBn connected in series and the cathode of the other, i.e., the anode of the white LED dB1 and the cathode of the white LED dBn, are connected to another one of the power supply circuits in the LED driving circuit 20, i.e., a power supply control circuit 21B. The anode of one of the outermost ones of the white LEDs dC1, dC2, dC3, . . . dCn connected in series and the cathode of the other, i.e., the anode of the white LED dC1 and the cathode of the white LED dCn, are connected to a further one of the power supply circuits in the LED driving circuit 20, i.e., a power supply control circuit 21C. The anode of one of the outermost ones of the white LEDs dD1, dD2, dD3, . . . dDn connected in series and the cathode of the other, i.e., the anode of the white LED dD1 and the cathode of the white LED dDn, are connected to the other one of the power supply circuits in the LED driving circuit 20, i.e., a power supply control circuit 21D.

The white LEDs in each light emitting area EAi (i=1, 2, 3, . . . n), i.e., the white LEDs in each of the light emitting areas EA1, EA2, EA3, . . . EAn, are arranged such that they are connected to the power supply control circuits 21A, 21B, 21C and 21D, respectively, which apply driving voltages. That is, the position of each of the white LEDs in each light emitting area EAi is determined in accordance with which of the power supply control circuits 21A, 21B, 21C and 21D is connected to each white light LED.

The power supply control circuit 21A has a function of detecting current flowing in the white LEDs dA1, dA2, dA3, . . . dAn connected in series. To be more specific, since the cathodes of the white LEDs dA1, dA2, dA3, . . . dAn are not grounded, the power supply control circuit 21A can highly accurately detect the current flowing in the white LEDs dA1, dA2, dA3, . . . dAn without being influenced by current flowing in the white LEDs connected to the other power supply control circuits, i.e., the power supply control circuits 21B, 21C and 21D. The power supply control circuit 21A adjusts the value of a driving voltage VdA based on the value of the detected current and the duty ratio of a PWM signal input as a brightness control signal to the power supply control circuit 21A.

The power supply control circuit 21B has a function of detecting current flowing in the white LEDs dB1, dB2, dB3, . . . dBn connected in series. To be more specific, since the cathodes of the white LEDs dB1, dB2, dB3, . . . dBn are not grounded, the power supply control circuit 21B can highly accurately detect the current flowing in the white LEDs dB1, dB2, dB3, . . . dBn without being influenced by current flowing in the white LEDs connected to the other power supply control circuits, i.e., the power supply control circuits 21A, 21C and 21D. The power supply control circuit 21B adjusts the value of a driving voltage VdB based on the value of the detected current and the duty ratio of a PWM signal input as a brightness control signal to the power supply control circuit 21B.

The power supply control circuit 21C has a function of detecting current flowing in the white LEDs dC1, dC2, dC3, . . . dCn connected in series. To be more specific, since the cathodes of the white LEDs dC1, dC2, dC3, . . . dCn are not grounded, the power supply control circuit 21C can highly accurately detect the current flowing in the white LEDs dC1, dC2, dC3, . . . dCn without being influenced by current flowing in the white LEDs connected to the other power supply control circuits, i.e., the power supply control circuits 21A, 21B and 21D. The power supply control circuit 21C adjusts a driving voltage VdC based on the value of the detected current and the duty ratio of a PWM signal input as a brightness control signal to the power supply control circuit 21C.

The power supply control circuit 21D has a function of detecting current flowing in the white LEDs dD1, dD2, dD3, . . . dDn connected in series. To be more specific, since the cathodes of the white LEDs dD1, dD2, dD3, . . . dDn are not grounded, the power supply control circuit 21D can highly accurately detect the current flowing in the white LEDs dD1, dD2, dD3, . . . dDn without being influenced by current flowing in the white LEDs connected to the other power supply control circuits, i.e., the power supply control circuits 21A, 21B and 21C. The power supply control circuit 21D adjusts a driving voltage VdD based on the value of the detected current and the duty ratio of a PWM signal input as a brightness control signal to the power supply control circuit 21D.

The value of the brightness control signal is the value of the PWM signal generated from the PWM circuit 112B.

In such a manner, as shown in FIG. 3, the currents flowing in the white LEDs in each light emitting area are controlled by the different power supply control circuits, i.e., the power supply control circuits 21A to 21D, respectively. As a result, even if the brightnesses of the LEDs in each light emitting area are different, the brightness of the LCD is substantially uniform over the entire surface. Also, the LEDs can be stably driven. Furthermore, since the power supply control circuits 21A to 21D can highly accurately detect the currents flowing in the white LEDs, feedback can be also highly accurately performed, thereby reducing the nonuniformity in brightness, i.e., improving the uniformity in brightness.

In a light source using conventional white LEDs, the white LEDs in each light emitting area is driven by the same power supply control circuit. In many cases, a terminal for use in supplying a driving voltage to the white LEDs is provided at an end portion of the printed-circuit board. Therefore, the lengths of circuit lines connecting the terminal and the white LEDs connected in series to each other vary from one light emitting area to another. In such a manner, if the lengths of the circuit lines vary, the driving voltage greatly varies from one light emitting area to another (i.e., the driving voltages output from the respective power supply control circuits are greatly different) due to the resistances of the circuit lines. Consequently, the brightness easily varies from one light emitting area to another.

On the other hand, in the embodiment of the present invention, the white LEDs in each of the light emitting areas are driven by the respective power control circuits. Thus, circuit lines connecting the white LEDs dA1, dA2, dA3, . . . dAn in series to each other, circuit lines connecting the white LEDs dB1, dB2, dB3, . . . dBn in series to each other, circuit lines connecting the white LEDs dC1, dC2, dC3, . . . dCn in series to each other, and circuit lines connecting the white LEDs dD1, dD2, dD3, . . . dDn in series to each other can be provided to have the same length. Accordingly, the driving voltages (output from the power supply control circuits) are not greatly different, and the brightness of the surface of the LCD 17 is thus made uniform.

Moreover, in the above light source using the conventional white LEDs, as described above, the white LEDs in each light emitting area are driven by the same power supply control circuit. Consequently, if the white LEDs in any of the light emitting areas become unable to emit light, part of information displayed on the LED, which cannot be viewed, is concentrately located in a single block of the LED. Thus, there is a possibility that the information could not be recognized. On the other hand, in the embodiment of the present invention, even if the white LEDs connected to any of the power supply control circuits become unable to emit light, information displayed on the LCD 17 can be recognized, since parts of the information which cannot be viewed are small, and are separated from each other as shown in FIG. 5.

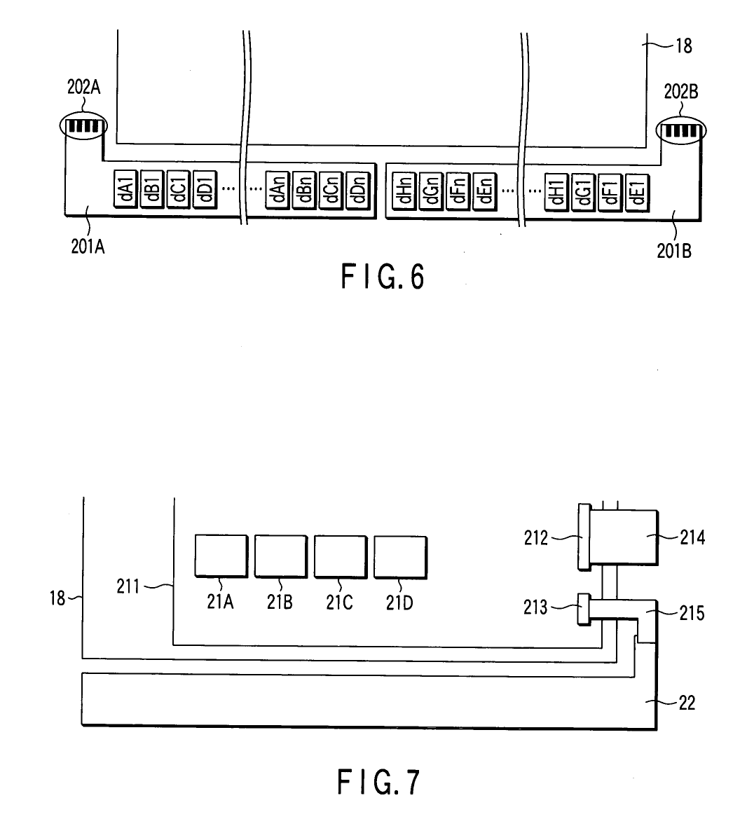

It should be noted that in the case where the screen is formed to have a large size, the number of LEDs to be driven in parallel with each other is large, as a result of which it is necessary to increase the voltage, and also to increase the width of each of the circuit lines connected to the white LEDs. Thus, in order to increase the width of each circuit line, the outer diameter of the printed-circuit board needs to be also increased. However, according to the embodiment of the present invention, the screen can be enlarged without increasing the widths of the circuit lines. This will be explained with reference to FIG. 6.

As shown in FIG. 6, a first printed-circuit board 201A and a second printed-circuit board 201B are attached to one end portion of the light guiding plate 18. On the first printed-circuit board, white LEDs dA1, dB1, dC1, dD1, . . . dAn, dBn, dCn and dDn are mounted, and on the second printed-circuit board, white LEDs dE1, dF1, dG1, dH1, . . . dEn, dFn, dGn and dHn are mounted.

In the first printed-circuit board 201A, a first terminal 202A is provided for applying driving voltages output from the power supply control circuits 21A, 21B, 21C and 21D to the white LEDs dA1, dB1, dC1, dD1, . . . dAn, dBn, dCn and dDn. In the second printed-circuit board 201B, a second terminal 202B is provided for applying driving voltages output from a plurality of power supply control circuits including the third and fourth power supply control circuits to the white LEDs dE1, dF1, dG1, dH1, . . . dEn, dFn, dGn and dHn. The first terminal 202A and the second terminal 202B are located such that the light guiding plate 18 is interposed between them. In such a manner, since the terminals 202A and 202B for applying driving voltages are provided on the left and right sides with respect to the light guiding plate 18, the widths of the circuit lines are not increased. That is, the outer diameter of the printed-circuit board is prevented from being increased.

Furthermore, the PWM circuit 112B and the graphics controller 114 are provided in the computer 11. In order that an image be displayed on the LCD 17, it is necessary that the PWM signal from the PWM circuit 112B and kinds of signals of a plurality of video signals from the graphics controller 114 are supplied to the display unit 112. In order that the kinds of signals be supplied, it is necessary to provide cables for use in supplying those signals, in the display unit 12, and also ensure space for providing the cables. A structure in which the space for provision of the cables can be restricted will be explained with reference to FIG. 7.

As shown in FIG. 7, an interface board 211 is provided on the rear surface side of the light guiding plate 18. On the interface board 211, the power supply control circuits 21A, 21B, 21C and 21D, a first terminal 212 and a second terminal 213 are provided. To the first terminal 212, a first flexible printed-circuit board 214 is connected. To the first flexible printed-circuit board 214, the PMW signal and video signal are supplied from the computer 11.

To the second terminal 213, a second flexible printed-circuit board 215 connected to the printed-circuit board 22 is connected. The power supply control circuits 21A, 21B, 21C and 21D respectively adjust the driving voltages VdA, VdB, VdC and VdD in accordance with the PWM signal supplied to the interface board 211. The driving voltages VdA, VdB, VdC and VdD are applied to the printed-circuit board 22 by the second flexible printed-circuit board 215 which connects the interface board 211 and the printed-circuit board 22.

By virtue of this structure, when the printed-circuit board 22 is connected to the interface board 211, the PWM signal and video signal can be supplied by one terminal, i.e., the first terminal 212. As a result, the first flexible printed-circuit board 214 can serve as a cable for use in supplying the driving voltages VdA, VdB, VdC and VdD and the video signal. That is, a plurality of cables does not need to be provided. Thus, the size of the structure can be prevented from being increased.

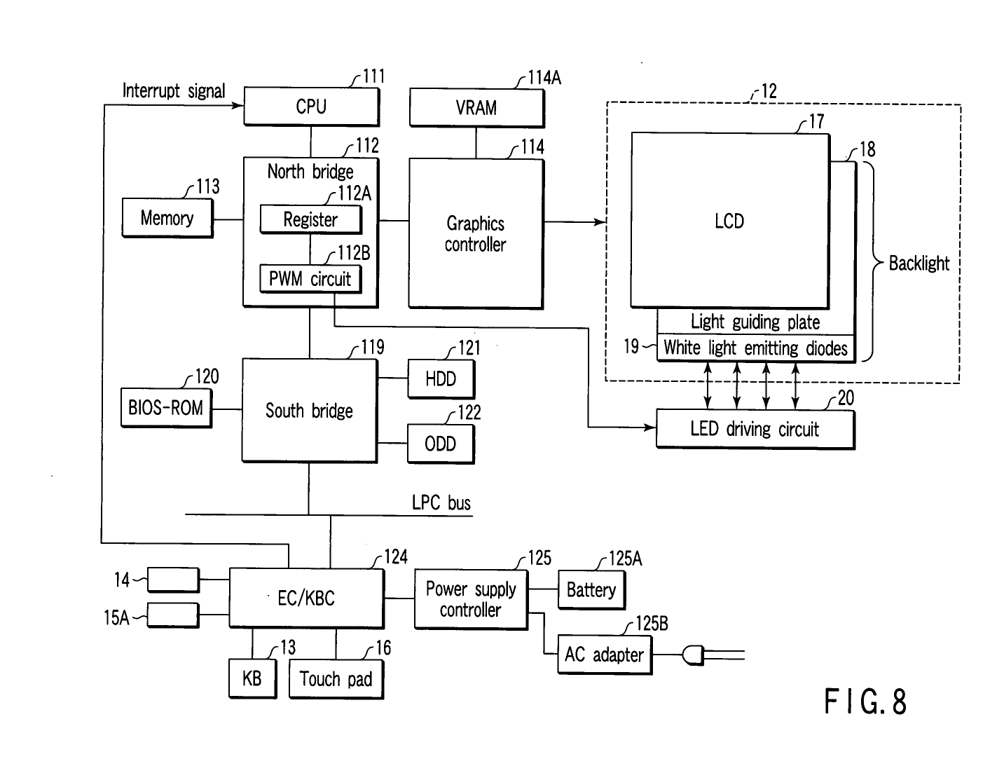

It should be noted that in the above notebook computer 10, the LED driving circuit 20 is provided in the display unit 12. However, as shown in FIG. 8, the LED driving circuit 20 may be provided in the computer main body 11.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display panel which displays an image;
a light source which illuminates the display panel, the light source including a first light emitting area in which first and second light emitting elements are arranged, and a second light emitting area which is adjacent to the first light emitting area, and in which third and fourth light emitting elements are arranged, the third light emitting element being connected in series to the first light emitting element, the fourth light emitting element being connected in series to the second light emitting element;
a first control circuit connected to an anode side of the first light emitting element and a cathode side of the third light emitting element, and configured to adjust a value of current flowing in the first and third light emitting elements; and
a second control circuit connected to an anode side of the second light emitting element and a cathode side of the fourth light emitting element, and configured to adjust a value of current flowing in the second and fourth light emitting elements.

2. The information processing apparatus according to claim 1, wherein a position of each of the light emitting elements in each of the first and second light emitting areas is determined in accordance with which of the control circuits is connected to the each light emitting element.

3. The information processing apparatus according to claim 1, wherein the light source includes a third light emitting area in which fifth and sixth light emitting elements are arranged, and a fourth light emitting area which is adjacent to the third light emitting area, and in which seventh and eighth light emitting elements are arranged, the seventh light emitting element being connected in series to the fifth light emitting element, the eighth light emitting element being connected in series to the sixth light emitting element, the information processing apparatus further comprising:
a third control circuit to which an anode of the fifth light emitting element and a cathode of the seventh light emitting element are connected, the third control circuit being configured to adjust a value of current flowing in the fifth and seventh light emitting elements;
a fourth control circuit to which an anode of the sixth light emitting element and a cathode of the eighth light emitting element are connected, the fourth control circuit being configured to adjust a value of current flowing in the sixth and eighth light emitting elements;
a first printed-circuit board in which the first and second light emitting areas and a first terminals, to which currents are to be fed from the first and second control circuits, are provided; and
a second printed-circuit board in which the third and fourth light emitting areas and a second terminals, to which currents are to be fed from the third and fourth control circuits, are provided.

4. The information processing apparatus according to claim 3, further comprising a light guiding portion configured to cause light from the first to fourth light emitting elements to be radiated from a surface of the light source, and the light guiding portion is interposed between the first and second terminals.

5. The information processing apparatus according to claim 1, further comprising:
a graphics controller configured to generate the video signal;
a brightness signal generating circuit configured to generate a brightness control signal;
a cable through which the video signal from the graphics controller and the brightness control signal are to be supplied; and
an interface board to which the cable is connected, and which includes the first and second control circuits and a second terminal for use in feeding current from the first and second control circuits to the first to fourth light emitting elements.

6. The information processing apparatus according to claim 1, wherein the first to fourth light emitting elements are mounted on a printed-circuit board including a plurality of wiring layers.

7. The information processing apparatus according to claim 1, wherein the first to fourth light emitting elements are mounted on a flexible printed-circuit board including a plurality of wiring layers.

8. The information processing apparatus according to claim 1, further comprises a brightness signal generating circuit configured to generate a brightness control signal,
wherein the first control circuit includes a circuit which is configured to detect values of current flowing in the first and third light emitting elements, and adjust values of current flowing in the first and third light emitting elements based on the brightness control signal generated by the brightness signal generating circuit and the detected values of the current flowing in the first and third light emitting elements, and
the second control circuit includes a circuit which is configured to detect values of current flowing in the second and fourth light emitting elements, and adjust values of current flowing in the second and fourth light emitting elements based on the brightness control signal generated by the brightness signal generating circuit and the detected values of the current flowing in the second and fourth light emitting elements.

9. The information processing apparatus according to claim 3 further comprises a brightness signal generating circuit configured to generate a brightness control signal,
wherein the third control circuit includes a circuit which is configured to detect values of current flowing in the fifth and seventh light emitting elements, and adjust values of current flowing in the fifth and seventh light emitting elements based on the brightness control signal generated by the brightness signal generating circuit and the detected values of the current flowing in the fifth and seventh light emitting elements, and
the fourth control circuit includes a circuit which is configured to detect values of current flowing in the sixth and eighth light emitting elements, and adjust values of current flowing in the sixth and eighth light emitting elements based on the brightness control signal generated by the brightness signal generating circuit and the detected values of the current flowing in the sixth and eighth light emitting elements.
